(19) United States
(12) Patent Application Publication
(10) Pub. No.: US 2003/0165741 A1
(43) Pub. Date: Sep. 4, 2003

(54) Multilayer electrode

(76) Inventors: Martha Maly-Schreiber, Moding (AT); Adam Harding Whitehead, Eisensadt (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/275,700

(22) PCT Filed: Apr. 4, 2001
(86) PCT No.: PCT/AT01/00097

(30) Foreign Application Priority Data
May 10, 2000 (AT) A 816/2000

(51) Int. Cl. H01M 4/80; H01M 4/66; H01M 4/74

(52) U.S. Cl. 429/235; 429/245; 429/244; 429/137; 429/209

(57) ABSTRACT

The invention relates to an essentially flat electrode of an electrochemical system, such as a battery or a capacitor. Said electrode is comprised of at least one conductive (3) and of a storage layer (4), which is connected to said conductive layer, has a lattice structure, is comprised of woven or knit plastic threads (5) that are rendered conductive, and in which electro-active material is embedded. The aim of the invention is to improve the volumetric and gravimetric energy density with an adequate mechanical stability and simplified production. To this end, the local lattice structure of the storage layer (4) is matched to the size and electrical conductivity of the particles (1) of the embedded electro-active material and is matched to the current density, which exists each time during the operation of the system, in such a manner that in the case of poor conductivity of the particles (1) and/or of high local current density, essentially each individual particle (1) is in direct contact with the lattice threads (5), whereas in the case of good conductivity of the particles and/or of low local current density, particles (1) that are not themselves in direct contact with the lattice threads (5) are also located in a lattice pocket (6).

The invention relates to a multi-layered and essentially flat electrode of an electrochemical system, particularly a battery or a capacitor, comprising of at least one highly conductive layer and a storage layer that is electrically connected to said conductive layer, a lattice structure having a storage layer made of woven or knitted plastic threads that are rendered conductive, preferably threads made of synthetic material, in which electro-active material is embedded together with possible additives.

In general, the electrochemical systems of this interesting type, as for instance alkaline Zn-manganese batteries, lithium-ion batteries, lithium batteries, lithium-polymer batteries, nickel metal hydride batteries, aqueous and non-aqueous super capacitors and the like, have one or several electrodes, among other things, which are made themselves of a composition of electro-active material and possible diverse additives together with a current carrier. The electric conductor in this composite is mostly a three-dimensional metallic lattice, an etched or perforated foil, metal mesh or the like. Examples are disclosed, for instance, in U.S. Pat. No. 5,750,289 A, EP 0 764 489 A or DE 40 19 092 A.

The utilized electro-active materials appear mostly in the form of powder and they may perform storage and dispersion reactions, surface absorptions and desorption reactions or displacement reactions whereby corresponding electrochemical processes occur in a known manner. Electro-active powder materials for purposes of this type are disclosed in Vincent, C. A. and B. Scrosati, Modern Batteries, 2^{nd} ed., 19971; London: Arnold and Linden D., Handbook of Batteries, 2^{nd} ed., 1995; New York: MacGraw-Hill or Winter, M., et al., Insertion Electrode Materials for Rechargeable Lithium Batteries, Adv. Mater., 1998, 10(10): p. 725-763.

It is the function of the conductive threads or the electric current carriers, in general, to provide an electric connection with the least possible resistance for the electrons between the active electrode material and an external electric current or an interconnected additional electrode of the same arrangement. The connection from the outside to the conductive structures within the electrode is established mostly via connection edge strips or a corresponding contact point having good electrical contact. On the inside of the electrode structure, there exists oftentimes the problem that the above-mentioned electro-active material is in most cases a poor electrode conductor itself. In addition, the electro-active particles of the electro-active material have oftentimes only point contacts to other neighboring particles, which leads most often to the fact that conductive additives have to be added to the electrons traveling in the electrode to improve electric current carrying capability whereby said additives contribute to the mass and volume as a matter of course and thus reduce the gravimetric and volumetric energy density of the system. Furthermore, volume changes of electro-active materials during charging and discharging may be the cause that electro-active material is mechanically separated from the remaining electrode material, which leads to a gradual loss in charging capacity at each charging cycle in batteries, for example.

The mass of the electric current carrier structure represents usually a considerable part of the total mass of a battery or an accumulator and said mass considerably influences therefore the gravimetric energy density of the entire system. Self-supporting metallic electric current carriers in the form of porous, sintered metal bodies—as disclosed in the aforementioned [patent] EP 0 764 489 A, for example —have a relatively high density and they are costly and inflexible as well, and there remains correspondingly little room for electro-active material based on the high intrinsic density, which unfavorably reduces the energy density of the system itself. The alternative thereto is the use of a lightweight, flexible, nonconductive substrate material unto which there is applied a thin, continuous, electron-conducting layer. Arrangements of this type, having multi-layered, three-dimensional composite electrode structures, are also disclosed in the aforementioned [patent] DE 40 19 092 A, which offers nevertheless more space for electro-active material to be stored; but it also decreases the stability of the electrodes. In both cases, there remains additionally the problem mentioned in the disclosed arrangement of having a low intrinsic conductivity of the electro-active material compared to the three-dimensional electric current carrier structure of the electrode composition.

The object of the present invention is to improve electrodes of the aforementioned known type in a manner that the cited disadvantages are avoided and that an improvement of energy density is made possible through simple means, particularly by having a strong but flexible structure.

For the achievement of the object relating to an electrode system of the aforementioned type, it is proposed according to the present invention that the local geometry of the lattice structure of the storage layer is matched to the size and the electrical conductivity of the particles of the embedded electro-active material and is matched to the electric current density existing during the respective operation of the system in such a manner that, in case of poor conductivity of the particles and/or of high local electric current density, essentially each individual particle is in direct contact with the lattice threads, whereas, in case of good conductivity of the particles and/or of low local electric current density, particles without their own direct contact with the lattice threads have room in a lattice pocket, whereby the local geometry of the lattice structure of the storage layer is matched to the size and the electrical conductivity of the particles of the embedded electro-active material and is matched to the electric current density existing during the respective operation of the system in such a manner that, in case of poor conductivity of the particles and/or of high local electric current density, essentially each individual particle is in direct contact with the lattice threads, whereas, in case of good conductivity of the particles and/or of low local electric current density, particles without their own direct contact with the lattice threads have room in a lattice pocket, whereby the lattice pockets have a larger volume with added distance away from the conductive layer and/or from the external connection of the conductive layer. The invention is based on the theory that a spatially higher concentration of [electric current] carrier threads in the lattice structure of the storage layer is only of an advantage if there is either poor conductivity of the electro-active particles themselves and/or a high local electric current density exists whereby said high concentration of carrier threads increases the stability of the structure; however, it negatively influences the volumetric and gravimetric energy density of the electrode. Said poor conductivity is caused by the utilized electro-active material, and said high local electric current density is basically caused by the removal of the respective lattice section from the discharge connection leading to the outside (in the vicinity of the actual discharge connection leading to the outside, there are, of course, higher electric current densities than in regions that are further away from said discharge connection.)

The adjustment of the local geometry of the lattice [structure] made of woven plastic threads may be performed in a simple manner by changing the parameters of the weaving or knitting technology whereby it is basically unimportant whether the lattice structure is first woven or knitted from plastic threads and then rendered conductive altogether in a suitable manner—or if weaving and knitting is performed using plastic threads that were made conductive previously. It must be pointed out here that manufacturing of the flat lattice structure by either weaving (from at least two threads (warp and weft) or from several threads) or by knitting (interknitting, crocheting, interlacing using a single thread) is of equal quality for the purpose of the present invention. Even where weaving is indicated in the following text, all other suitable methods for manufacturing of such lattice structures are included. Other suitable natural or manmade materials may be used in this manufacturing method beside the use of the preferred plastic threads.

The storage layer of the electrode of the invention is provided normally with a lattice structure, which has horizontal and/or vertical lattice spaces or a web density that are/is not always the same, whereby sometimes only individual or very few particles have room in a single lattice pocket depending on the adjustment of the number of the particles of the embedded electro-active material —whereas in other regions of the storage layer, there may be several or many particles of the electro-active material together in one lattice pocket.

In an additional embodiment of the invention, it is proposed that the lattice pockets of the storage layer are essentially square. This simplifies weaving of the storage layer whereby the actual size of the respective lattice pockets is adjusted in the above-described manner to the size and the electric conductivity of the particles of the embedded (or to be embedded) electro-active material and to the respectively existing electric current density.

According to an additional preferred embodiment of the invention, the storage layer may be composed multi-layered with layers being at an equal distance apart but having a web density that is continually decreasing at distances away from the conductive layer. This results also in a simplification during weaving of the storage layer whereby the layered composition makes possible the described advantages of the inventive design.

According to an especially preferred additional embodiment of the invention, it is proposed that at least one layer of the storage layers is provided with an interwoven pattern having a web density that increases, at least partially, toward the exterior connection of the conductive layer. Each individual layer of the multi-layered storage layer corresponds thereby to the application of the inventive theory wherein the necessary lattice contact of the electro-active particles is locally different in the storage layer depending on the distance to the actual discharge of the electrons.

According to an especially preferred additional embodiment of the invention, the conductive layer and the storage layer are mutually interwoven three-dimensionally, they have layers of different sizes and/or they have a locally varying web density, and they are made—at least partially—of polymer material consisting of fibers that have a conductive coating. This makes possible an especially simple production of the electrode, according to the invention, through the interwoven design of the conductive layer and the storage layer, and which makes a subsequent conductive connection between said layers unnecessary (as it is described, for example, in the aforementioned patent DE 40 19 192 A.) Of course, the conductive layer is clearly woven with a considerably higher density than the individual regions of the storage layer since no electro-active material has to be picked up and held thereon in any manner. In reference to the conductive layer, there could be performed a local adjustment of the respective web density to the extent that a higher web density is selected in the direction toward the external discharge connection to be able to facilitate and increase current density in that area—while outward areas could again have a lower web density, which would favorable influence the weight of the entire system.

In an additional embodiment of the invention, there is proposed that the woven conductive layer of the highest local web density occupies up to a maximum of 50 percent of the total thickness of the flat electrode, which represents a good compromise in the choice between discharge capacity, on one hand, and electric-active volume, on the other hand.

According to another embodiment of the invention, the storage layers that are interwoven with the conductive layer may be arranged not only on one side of the conductive layer, but also on both sides of the conductive layer, which offers also a favorable influence of the total characteristic of the electrode or the electrochemical arrangement having an electrode of this type.

In a preferred additional embodiment of the invention, the lattice threads of the storage layer and possibly the ones of the conductive layer have a thickness in the range of 0.08 to 1.0 mm, which makes covering of many different systems possible that have electrode designs of the above-mentioned type.

In an additional preferred embodiment of the invention, the lattice threads of the storage layer and possibly the ones of the conductive layer are coated with a continuous coating having a thickness of 0.01 to 1.0 mm and they are made of metals of the group Cu, Fe, Ti, Ni, Cr, Al, Ag, Au, Mn, stainless steel or their alloys, or of other conductive substances as, for instance, conducting oxides, conducting carbon powder or the like, whereby it could be proposed that said continuous coating is covered with a second corresponding coating made of the group of the following metals or their alloys (Cu, Fe, Ti, Ni, Cr, Al, Ag, Au, Mn, and stainless steel) or of conducting oxides or conducting carbon powder, whereby the total thickness of the two layers does not exceed 15 micrometers. Many diverse systems or utilized materials may be coated by employing the application in this embodiment.

In an additional embodiment of the invention, the weaving threads of the three-dimensional lattice consist preferably of fibers made of a polymer of the following group: polyester, silicone rubber, polyethylene, ethylenetetrafluoro-ethylene, copolymer, polytetrafluoro-ethylene, and polyvinylidene fluoride.

According to an especially preferred additional embodiment of the invention, the storage layer and/or the conductive layer may have additional metallic threads on their own, which are interwoven at regular intervals and made of a metal of the group: Cu, Fe, Ti, Ni, Cr, Al, Ag, Au, Mn, stainless steel, or their alloys, preferably having a diameter that corresponds in it size to the diameter of the conductive coated plastic fibers, whereby the mass of the metallic threads does not exceed approximately 30 percent of the [total] mass of the electrode. To this end, the conductivity in the three-dimensional lattice of the electrode can furthermore be influenced locally as needed and it can be adjusted to the respective requirements whereby a [sufficient] coverage can be usually achieved with a relatively low percentage of altogether conductive threads of this type, so that the total weight of the electrode does not have to be increased unnecessarily.

In the following, the invention is additionally explained in more detail with the aid of the accompanying schematic drawings clarifying the embodiment examples. FIG. 1 shows thereby the arrangement of electro-active particles in a battery, for example, on a single electric current carrier according to prior art. FIG. 2 shows a similar arrangement as shown in FIG. 1 in a basic embodiment of the present invention. FIG. 3 through FIG. 5 show differently designed lattice structures of the conductive layer and the storage layer of the electrodes, respectively, according to the present invention.

In the arrangement according to the state-of-the-art shown in FIG. 3, a plurality of individual particles 1 of electro-active material is placed into an essentially flat electrode of an electrochemical system (not totally illustrated), such as a battery, so that the individual particles 1 have nevertheless contact points 2 between each other; however, only a few particles 1 located adjacent to a conductive layer 3 have direct contact with the conductive layer 3 itself. Since the utilized electro-active materials in electrochemical systems of this interesting type have very often only a relatively low intrinsic conductivity, it means that the electric current is highly restricted from or to the particles 1 that are further away from the conductive layer 3, which subsequently has a negative effect on the total energy density of the system. In addition, a large number of mechanically unsupported particles 1 that are disposed in the same region represent also a relatively large risk for mechanical instability of the system, which can lead to damages in structural integrity and to further lowering of the energy density related thereto. The gravimetric energy density of the system is lowered as well through the necessity of inserting additives between the particles 1 to increase the conductivity of systems of this type.

As schematically illustrated in FIG. 2, the local geometry of the lattice structure of the storage layer 4 in electrodes, according to the invention, is adjusted to the size and electric conductivity of the particles 1 of the embedded electro-active material and to the electric current density existing therein, respectively, during operation of the system in such a manner that at poor conductivity of the particles 1 and/or at high local electric current density, essentially each one of the particles 1 has direct contact with the lattice threads 5 at the locations 2—and thereby also to the conductive layer—whereas at good conductivity of the particles and/or lower local current density, particles 1 without their own direct contact with the lattice threads 5 have room in a lattice pocket 6 (not shown in FIG. 2). In this respect, poor conductivity of the particles 1 themselves is unimportant, but a high mechanical stability of the storage layer 4 or of the entire electrode has been ensured. Furthermore, no conductive additive or the like has to be used, which additionally improves the gravimetric energy density.

With the arrangements in FIG. 2, there are considerably shorter electronic passages guaranteed leading up to the electric current carrier through very few or no point contacts between the individual particles 1 whereby the electric leakage resistance between the electro-active material and the electric current carrier is decreased altogether. Lower resistance between the electro-active material and the electric current carrier means that less power is wasted as lost heat, whereby the power loss is directly proportional to said resistance. Maximum power as well as charging and discharging efficiency of an energy collector is increased in which electrodes are installed according to the invention. Equally, the resistance loss factor is reduced when such electrodes are used in a super capacitor. In addition, the amount of necessary conductive additives and binders is considerably decreased or such additives may be completely unnecessary if the system is used according to the present invention.

FIG. 3 through FIG. 5 show respectively only small areas of the lattice structure in the conductive layer and the storage layer of electrodes for electrochemical systems according to the invention—for better viewing, there are not shown the particles of the electro-active material, the possible additional additives, the external electric connections on the conductive layer, the outer cover layer and the like. The conductive layer 3 is in all cases interwoven with the storage layer 4 in a three-dimensional, layered manner and/or with a locally varying web density (or knit density) and said layers are at least partially made of electricity-conducting coated fibers consisting of polymer material. Whether coating of the fibers is performed before or after weaving of the material is unimportant or it is an issue of the respective preferred weaving technology.

According to FIG. 3, the lower storage layers 4 disposed closer to the conductive layer 3 have smaller lattice pockets 6 or smaller lattice dimensions, whereas the storage layers 4 being further away from the conductive layer 3 are provided nevertheless with larger lattice pockets 6. Assuming there are the same size of electro-active particles in the entire storage layer 4 throughout, then this has the result that in the lower region, each individual particle is essentially in direct contact with at least one of the lattice threads 5, whereas in the upper and more loosely woven region, single particles of the electro-active material may find room in the lattice pockets 6 that have no direct contact themselves with the conducting lattice threads 5. This does nor represent a problem since the current density is, or course, considerably higher near the conductive layer 3 than in the outer region that is further away. In this way, the electric current can be distributed evenly whereby necessary stability is ensured through the inner tighter-woven layers, whereas more electro-active material has room in the larger outer lattice pockets 6, which considerably improves, as a whole, the volumetric and gravimetric energy density of the system compared to systems of prior art.

In FIG. 4 is now an arrangement illustrated in which the storage layers have different dimensions in the vertical as well as in the horizontal direction, which makes possible, in a simply way, to improve the electric current carrier through tighter-woven lattice threads 5 in the region at the right lower corner of the arrangement in the illustration at immediate reduction of the volume that is not burdened by materials that are not electro-active. Starting from the upper left and continuing to the lower right [corner], the probability increases for each individual lattice pocket 6 that each individual electro-active particle located in the respective lattice pocket has direct contact with an electricity-conducting lattice thread 5.

In the arrangement according to FIG. 5, the region of the storage layers 4 is designed similar to the one in FIG. 3. The conductive layer 3 is hereby woven in such a manner that its thickness continually increases toward the electric discharge at the outside (lower right), which applies to the flow of electric current as well.

Since the mass of the material—which is necessary for the electric current discharge in the conductive layer as well as in the storage layer—represents a considerable part of the total mass of the battery, for example, the gravimetric energy density of an electrochemical system equipped with such electrodes is very positively influenced according to the described inventive embodiment, whereby the illustrated and described lattice structures are flexible enough to hold the electro-active material, in spite of its high mechanical rigidity, to allow rolling or folding of the electrodes without causing damage thereto, for example. The three-dimensionally interwoven polymer materials, which basically form the lattice structure of the flat electrodes, can be manufactured cost-effective and in a simple manner in large quantities by using known weaving or knitting technologies. As long as the individual layers in the region toward the external electric connection are to have different or changing web densities (as described), then this can be realized in a very simple manner in the way of woven-in patterns whereby after the weaving of whole widths of such material, the specific sections can be cut out or punched out.

The utilized fiber element may be composed of one or several threads per fiber whereby the fiber material is to be selected in such a manner that it is non-reactive as much as possible in the electrochemical system and does not have a chemical reaction or change in volume. Preferred materials and material combinations in this respect are described in the claims. The conductive coating of plastic fibers of the lattice structures can also consist of two layers, as previously described. In the present system there is preferably a coating with high electric conductivity applied directly onto the plastic fiber, and on top of said first coating a second coat is applied having increased corrosion resistance. The thickness of the coating applied on the plastic fibers for conduction must also be selected in such a manner that the conductivity for the respective existing electrochemical system corresponds to the specific geometry, size and required characteristics. The application of said conductive coating onto the plastic fibers can be performed by various known methods, for instance by metal depositing without foreign current or by metal depositing without foreign current in conjunction with galvanic reinforcement of the coatings or by destabilization of a dispersion of electricity-conducting particles. The plastic fibers of the lattice are preferably metal-coated (metallized) only after the weaving process. The weaving of fibers that were previously rendered conductive is usually preferred in cases in which the coating of the completely woven structure is difficult to do, time-consuming and costly, for example, when the conductive layer has a very high web density and thickness.

To increase conductivity as needed, particularly that of the conductive layer, separate metallic threads can be additionally interwoven into the lattice structure (not separately shown in the drawings) whereby said threads may be made of the same material throughout as, for example, the metallic coatings of the neighboring plastic fibers and they should have a thickness at least in the same order of magnitude.

1. A multi-layered and essentially flat electrode of an electrochemical system, particularly a battery or a capacitor, comprising of at least one highly conductive layer (3) and a storage layer (4) that is electrically connected to said conductive layer, a lattice structure having a storage layer made of woven or knitted plastic threads (5) that are rendered conductive, preferably threads made of synthetic material, in which electro-active material is embedded together with possible additives, characterized in that the local geometry of said lattice structure of said storage layer (4) is matched to the size and the electrical conductivity of the particles (1) of the embedded electro-active material and to the electric current density existing during the respective operation of said system in such a manner that, in case of poor conductivity of the particles (1) and/or of high local electric current density, essentially each individual particle (1) is in direct contact with said lattice threads (5), whereas, in case of good conductivity of the particles and/or of low local electric current density, particles (1) without their own direct contact with said lattice threads (5) have room in a lattice pocket (6), whereby the lattice pockets (6) have a larger volume with added distance away from the conductive layer (3) and/or from an external connection of the conductive layer (3).

2. An electrode according to claim 1, wherein the lattice pockets (6) of said storage layer (4) are essentially square.

3. An electrode according to claim 2, wherein said storage layer (4) may be composed multi-layered with layers being at an equal distance apart but having a web density that is continually decreasing at distances away from said conductive layer (3).

4. An electrode according to claim 2 or 3, wherein at least one layer of said storage layers (4) is provided with an interwoven pattern having a web density that increases, at least partially, toward the exterior connection of said conductive layer (3).

5. An electrode according to one or several of the claims 1 through 4, wherein said conductive layer (3) and said storage layer (4) are mutually interwoven three-dimensionally whereby they have layers of different sizes and/or they have a locally varying web density, and they are made—at least partially—of polymer material consisting of fibers (5) that have a conductive coating.

6. An electrode according to claim 5, wherein the woven conductive layer (3) of the highest local web density occupies up to a maximum of 50 percent of the total thickness of the flat electrode.

7. An electrode according to claim 5 or 6, wherein interwoven storage layers (4) are arranged on both sides of said conductive layer (3).

8. An electrode according to one or several of the claims 1 through 7, wherein the lattice threads (5) of said storage layer (4) and possibly the ones of said conductive layer (3) have a thickness in the range of 0.08 to 1.0 mm.

9. An electrode according to one or several of the claims 1 through 8, wherein said lattice threads (5) of said storage layer (4) and possibly the ones of said conductive layer (3) are coated with a continuous coating having a thickness of 0.01 to 1.0 mm, and whereby said threads are made of metals of the group Cu, Fe, Ti, Ni, Cr, Al, Ag, Au, Mn, stainless steel or their alloys, or of other conductive substances as, for instance, conducting oxides, conducting carbon powder or the like.

10. An electrode according to claim 9, wherein said continuous coating is covered with a second corresponding coating made of the group of the following metals or their alloys (Cu, Fe, Ti, Ni, Cr, Al, Ag, Au, Mn, and stainless steel) or of conducting oxides or conducting carbon powder, whereby the total thickness of the two layers does not exceed 15 micrometers.

11. An electrode according to one or several of the claims 1 through 10, wherein said plastic weaving threads (5) consist of fibers made of a polymer of the following group: polyester, silicone rubber, polyethylene, ethylenetetrafluoro-ethylene, copolymer, polytetrafluoro-ethylene, and polyvinylidene fluoride.

12. An electrode according to one or several of the claims 1 through 11, wherein metallic threads are interwoven at regular intervals in said storage layer (4) and/or said conductive layer (3) whereby said metallic threads are made of a metal of the group: Cu, Fe, Ti, Ni, Cr, Al, Ag, Au, Mn, stainless steel, or their alloys, and whereby said metallic threads have a diameter that corresponds in it size to the diameter of the conductive coated fibers.
